(19) United States
(12) Patent Application Publication
(10) Pub. No.: US 2013/0227525 A1
(43) Pub. Date: Aug. 29, 2013

(54) Delivery of Changesets by Environment

(71) Applicants: Lisa Seacat DeLuca, San Francisco, CA (US); Soobaek Jang, Hamden, CT (US)

(72) Inventors: Lisa Seacat DeLuca, San Francisco, CA (US); Soobaek Jang, Hamden, CT (US)

(73) Assignee: INTERNATIONAL BUSINESS MACHINES CORPORATION, Armonk, NY (US)

(21) Appl. No.: 13/406,582

(22) Filed: Feb. 28, 2012

(51) Int. Cl. G06F 9/44; G06F 9/45

(52) U.S. Cl. 717/122; 717/120

(57) ABSTRACT

A method for allowing selective delivery of changesets by environment includes selecting at least one value in software code of a software program; specifying at least one environment for the selected at least one value; compiling the software code in each specified at least one environment; delivering the software code to a central repository; determining how the specified at least one environment is defined; and choosing at least one environment to build against, thereby ensuring that only software code for the chosen environment is pulled from the central repository.

### BACKGROUND

The present invention relates generally to a system and method for ensuring consistency in software code during software development. More particularly, the present invention relates to a system and method that allows software developers to safely deliver code changes or changesets during the software development process without affecting other developers and/or environments.

Software developers write, maintain, and integrate computer programs including source code as part of the development of software products. During this process, software developers are often organized in teams of individual programmers with each programmer and/or team being responsible for certain aspects or modules of a software deliverable. These deliverables are then integrated to produce the final software product.

Various methodologies and/or approaches are utilized in the software (or application) development process. Each of the software development methodologies may include stages (often referred to as the software development lifecycle) such as market research, requirements analysis, problem analysis, software planning or design, software testing, software launch (deployment), and troubleshooting (debugging). Some or all of these stages may be performed in a variety of orders or iterations depending on the particular business requirements and/or development strategies.

In the software development life cycle, it is common for developers to change some values or code in order to differentiate environmental variables or configurations so that applications can run in different environments such as local, development boxes, stage, or production.

Developers may accidentally deliver code changes that are intended for their local environment and not for another environment, such as production. For example, the submission of outgoing changes that should not have been delivered may result in variables for a production environment being overwritten, thereby causing deployment failures. This causes developers to constantly check outgoing and/or incoming code changes in detail and frequently presents additional debugging problems. This problem is often noticed after a developer “grabs” the code of other developers. For example, after “grabbing” the code, the developer notices that the production server is no longer behaving as expected or their individual local environment is no longer working. These problems can require significant troubleshooting and leads to wasted development efforts and frustration.

As illustrated in FIG. 1, a known example of an arrangement of software development files 100 includes a “Front-end development” parent file 105, an “Unresolved” file 110, and “Outgoing” 115 and “Incoming” 120 sub-files. In this arrangement, an Incoming changeset (updated web services references to point to localhost) may also change one of the local developer settings. If developers were to accept the changeset they would need to merge their local only changes or wipe them out and start over again. Similarly, an Outgoing changeset has to be explicitly indicated as “local” in the hope that other developers will not grab the changeset.

As illustrated in FIG. 2, developers may build software using different profiles 200 (Maven by the Apache Software Foundation). However, there remains a need to allow software developers to specify individual properties and configuration files per environment and/or per profile.

### BRIEF SUMMARY

According to one or more embodiments of the present invention, a method is provided for allowing selective delivery of changesets by environment. At least one value in software code of a software program is selected. At least one environment for the selected at least one value is specified. The software code in each specified at least one environment is compiled by a processor. The software code is checked into a central repository. The definition of the specified at least one environment is determined. At least one environment is chosen to build against, thereby ensuring that only software code for the chosen environment is pulled from the central repository.

According to another aspect of the present invention, a method for selective delivery of changesets includes selecting at least one value in software code changes for a software program; specifying at least one environment for the selected at least one value via a tag; compiling the software code changes in each tagged at least one environment; delivering the software code changes to a central repository; determining how the tagged at least one environment is defined; and choosing at least one environment to build against, thereby ensuring that only software code changes for the chosen environment are pulled from the central repository.

According to one or more embodiments of the present invention, a system for allowing selective delivery of changesets by environment is provided. The system includes a plurality of networked local developer workspaces, each workspace connected to a central repository; a compiler for compiling software code changes in at least one developer workspace or in the central repository; and at least one environment.

According to one or more embodiments of the present invention, a computer program product for selective delivery of changesets is provided comprising a computer readable storage medium. First program instructions select at least one value in software code of a software program. Second program instructions specify at least one environment for the selected at least one value. Third program instructions compile the software code in each specified at least one environment. Fourth program instructions deliver the software code to a central repository. Fifth program instructions determine how the specified at least one environment is defined. Sixth program instructions choose at least one environment to build against. Seventh program instructions pull only software code for the chosen environment from the central repository. The first, second, third, fourth, fifth, sixth, and seventh program instructions are stored on the computer readable storage medium.

### BRIEF DESCRIPTION OF SEVERAL VIEWS OF THE DRAWINGS

FIG. 1 illustrates a known example of software development files.

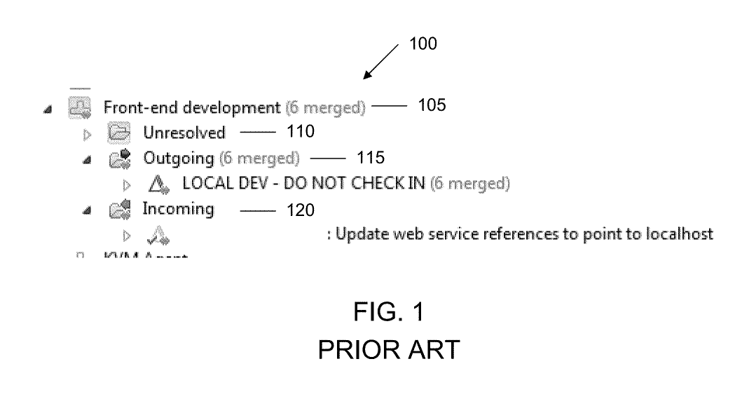

FIG. 2 illustrates a known example that allows software developers to build software code using different profiles.

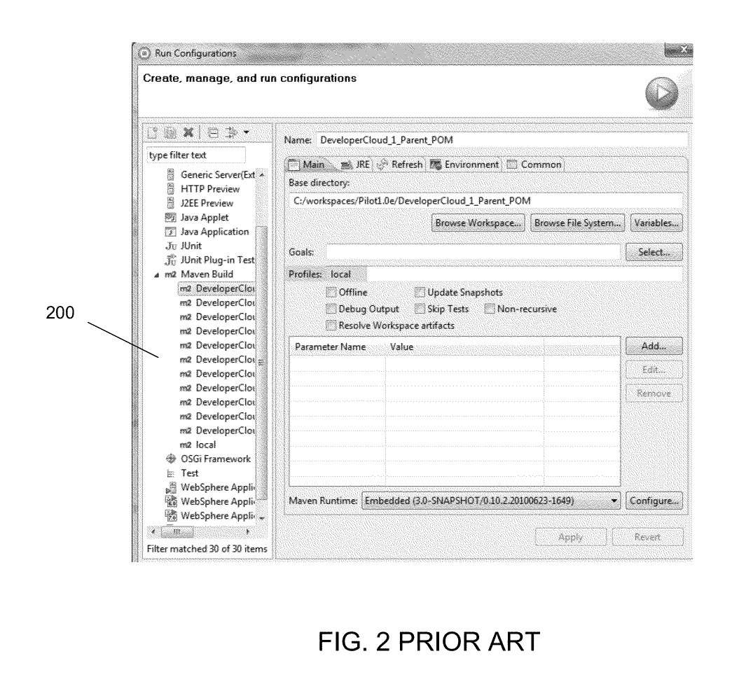

FIG. 3 is a schematic flowchart of a method according to an embodiment of the present invention.

FIG. 4 illustrates an example of a system for supporting the method according to an embodiment of the present invention.

FIG. 5 illustrates an example of another system for supporting the method according to an embodiment of the present invention.

Given the following enabling description of the drawings, the apparatus should become evident to a person of ordinary skill in the art.

### DETAILED DESCRIPTION

The present invention provides software developers with systems and methods to deliver their software or code changes (logical sets or changesets) during software development to a central repository without affecting other developers and/or other environments.

According to the present invention, software developers may specify, for example by selecting and/or tagging, which environments software or code changes are intended for. The specified software or code changes are delivered to the intended environments and, in specific embodiments, may be hidden as incoming changes to other, unintended developers. Thus, the present invention provides software developers with a useful tool for more effectively and efficiently delivering code without worrying about keeping outgoing changesets that should not be delivered.

Accordingly, the present invention allows software developers to safely deliver changesets to the central repository without overwriting variables that are needed for another environment, such as production deployment, as well as making sure other software developers do not see an inappropriate changeset coming into their workspace. Thus, there is a reduction in the human-error associated with delivering unwanted changesets. In addition, there is the added convenience of storing environment-specific variables in a central repository for later use (e.g., in cases where the variables are needed on a different workstation or where work is lost locally).

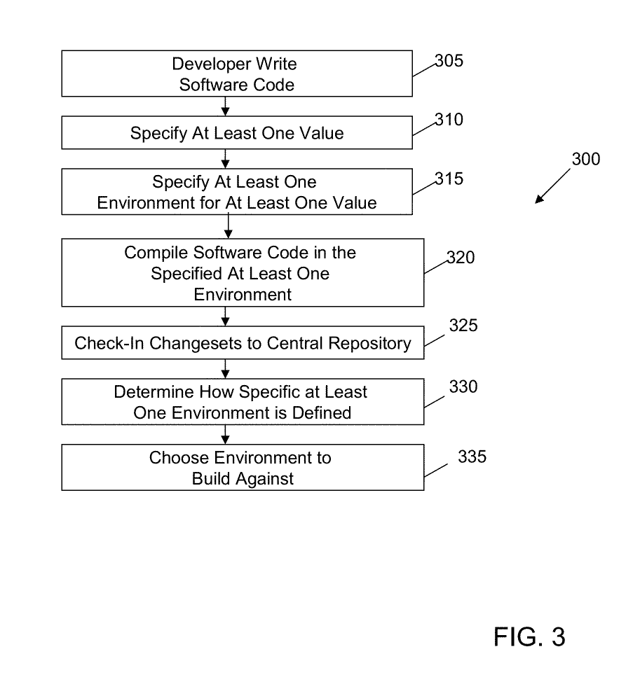

With reference now to FIG. 3, a schematic flowchart of a method 300 in accordance with an embodiment of the present invention is provided. Developers write software code, 305. When the developers get to a point in the software code where they need to specify at least one value for different environments, they select at least one of the file, variable, method, class, lines of code, or the like, 310.

For each at least one selected value, the developers specify at least one environment for which the selected at least one value should be applied, 315. In embodiments, the developers may specify an environment for the at least one value by selecting and/or tagging. For example, developers may select at least one environment by right clicking on provided menu options; double clicking on the menu options; using a keyboard shortcut (e.g., Control Key+E), or other appropriate means. Alternatively, or in addition thereto, the developers may specify at least one environment for the at least one value with a tag. A tag is a keyword or term associated with or assigned to a piece of information, thus describing the item and may enable at least one of keyword-based classification, search, or sharing of information.

The specified environment(s) may include, for example, at least one of a local environment; stage environment; problem analysis environment; testing environment; development environment; a troubleshooting environment; production environment; a tagged environment; all environments; or any subset or combination of environments.

The software code in the specified at least one environment is compiled, 320. The software code may be compiled throughout all environments. For example, the software code may properly compile for one environment (environment A), but there may be errors in compiling software code for a second environment (environment B). According to the present invention, the system may suggest to the developers who specified environment B that a modification either be applied to the code changes for the second environment and/or a new environment B alternative (e.g., environment C) be defined.

The developers deliver or check in their changesets to a central repository, 325. In specific embodiments, the software code may be compiled before or after the changesets are checked into the central repository. Thus, the code changes may be compiled in a developer's workspace or in the central repository workspace.

The system determines how the specified at least one environment is defined (i.e., by the selecting and/or by the tagging), 330. In a specific embodiment, the system determines which specified at least one environment is defined as “shared”. For example, if a developer specified an environment as “local” (not shared), the software code changes are not sent to a “group” environment, and the developer's “local” environment does not appear to have any outgoing changesets. If a developer specifies an environment as “shared”, the changesets from the developer are pushed to other developers in the shared environment. In a specific embodiment, a “shared” environment may be tagged across the entire system (all environments), for example, the tag “Production” may be recognized as “Production” for all developers or system users.

According to the present invention, at any time a developer may optionally suggest an environment to share with another developer or group of developers (e.g., a team). For example, Developer A may want to show Developer B a bug that she sees in her local workspace. The system allows Developer A to select her “local” environment and choose Share, so that her local environment is shared with Developer B.

Software developers choose which at least one environment to build against, 335. This choice pulls code changes or changesets from the central repository that are selected and/or tagged with that at least one environment. The pulled code changes or changesets are deployed. In addition, a developer may specify to build against any particular streams among those visible and hidden streams or perform all by configuration.

The developers repeat the above process for any new software code changes. Thus, according to the present invention, it is ensured that changesets are only applied to the intended environment(s). As a result, software developers are provided with an effective and efficient means of reliably handling code changesets.

A method is illustrated by the following, non-limiting example of the present invention.

### Example

Developer A delivers changeset 001, which contains a variable that is for Developer A's local environment, such as String Site_URL=http://localhost:9080/myweb/. However, in a production environment, this variable should be Private String Site_URL=http://www.ibm.com/myweb/. In addition, other developers might have application servers port defined differently so they might receive Private String Site_URL=http://localhost:9082/myweb/.

According to the present invention, Developer A may specify the changeset 001 as “local” through a selected delivery option and/or via a tag. Other developers will not see this changeset as incoming, i.e., the changeset will be hidden to them. The changeset is delivered to the central repository and will be placed into the “local” version of the hidden stream.

If Developer A specifies the changeset 001 as “stage” through a selected delivery option and/or via a tag, this will also cause other developers not to see this changeset as incoming, i.e., the changeset will be hidden. The changeset is delivered to the central repository and will be placed into the “stage” version of the hidden stream.

If Developer A fails to specify an environment for changeset 001 or specifies the changeset as “production”, other developers will see this changeset as incoming. The changeset is delivered to the central repository and will automatically be placed into the current visible version of the stream.

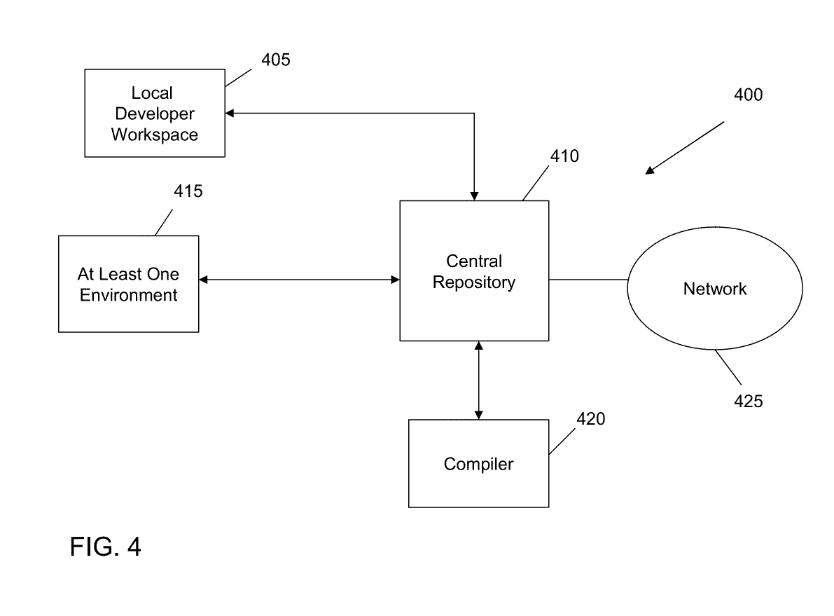

With reference now to FIG. 4, a system 400 according to an embodiment of the present invention comprises a local developer workspace 405 for at least one software developer; a central repository or electronic database 410 for checking in code changes or changesets from the local developer workspace; a compiler 420 for compiling code changes or changesets in the local developer workspace and/or in the central repository; at least one environment and/or stream 415; and a network 425 which may connect a plurality of local developers workspaces and the central repository. In embodiments, the compiler may comprise one or more processors having embedded code or application logic.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) present on a computer storage medium or computer program product, or an embodiment combining software and hardware aspects that may all generally be referred to herein as a “circuit,” “module” or “system.” Furthermore, aspects of the present invention may take the form of a computer program product embodied in at least one computer readable medium having computer readable program code embodied thereon.

Any combination of at least one computer readable medium may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having at least one wire, portable computer diskette, hard disk, random access memory (RAM), read-only memory (ROM), erasable programmable read-only memory (EPROM or Flash memory), optical fiber, portable compact disc read-only memory (CD-ROM), optical storage device, magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of at least one programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute with the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

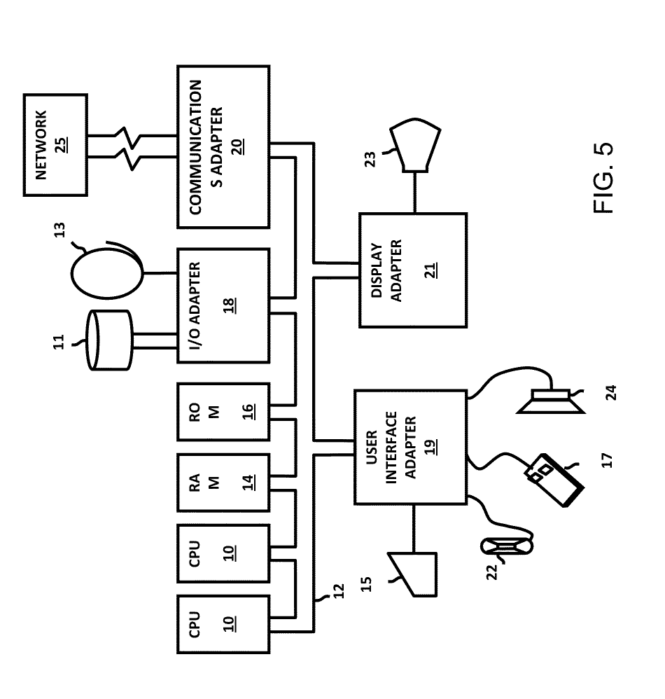

Referring now to FIG. 5, a representative hardware environment for practicing at least one embodiment of the invention is depicted. This schematic drawing illustrates a hardware configuration of an information handling/computer system in accordance with at least one embodiment of the invention. The system comprises at least one processor or central processing unit (CPU) 10. The CPUs 10 are interconnected with system bus 12 to various devices such as a random access memory (RAM) 14, read-only memory (ROM) 16, and an input/output (I/O) adapter 18. The I/O adapter 18 can connect to peripheral devices, such as disk units 11 and tape drives 13, or other program storage devices that are readable by the system. The system can read the inventive instructions on the program storage devices and follow these instructions to execute the methodology of at least one embodiment of the invention. The system further includes a user interface adapter 19 that connects a keyboard 15, mouse 17, speaker 24, microphone 22, and/or other user interface devices such as a touch screen device (not shown) to the bus 12 to gather user input. Additionally, a communication adapter 20 connects the bus 12 to a data processing network 25, and a display adapter 21 connects the bus 12 to a display device 23 which may be embodied as an output device such as a monitor, printer, or transmitter, for example.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises at least one executable instruction for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the root terms “include” and/or “have”, when used in this specification, specify the presence of stated features, integers, steps, operations, elements, and/or components, but do not preclude the presence or addition of at least one other feature, integer, step, operation, element, component, and/or groups thereof.

The corresponding structures, materials, acts, and equivalents of all means plus function elements in the claims below are intended to include any structure, or material, for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1. A method for selective delivery of changesets, comprising:
selecting at least one value in software code of a software program;
specifying at least one environment for the selected at least one value;
compiling the software code in each specified at least one environment by a processor;
delivering the software code to a central repository;
determining how the specified at least one environment is defined;
choosing at least one environment to build against; and
pulling only software code for the chosen environment from the central repository.

2. A method according to claim 1, wherein the at least one value comprises at least one of a file, variable, method, class, or lines of code.

3. A method according to claim 1, wherein said specifying at least one environment comprises selecting the at least one environment via a graphical user interface.

4. A method according to claim 1, wherein said specifying at least one environment comprises selecting the at least one environment via a menu option or a keyboard shortcut.

5. A method according to claim 1, wherein said specifying at least one environment comprises tagging the at least one environment.

6. A method according to claim 1, wherein the at least one environment comprises a local environment, problem analysis environment, testing environment, development environment, production environment, stage environment, a troubleshooting environment, a tagged environment, all environments, or any subset or combination of environments.

7. A method according to claim 1, comprising compiling the software code in each specified at least one environment in a local workspace prior to delivering the software code to the central repository.

8. A method according to claim 1, comprising compiling the software code in each specified at least one environment after delivering the software code to the central repository.

9. A method according to claim 1, wherein if compiling software code for the specified at least one environment indicates an error, a developer is notified.

10. A method according to claim 9, wherein the developer is notified that changes to the software code are needed or a new environment must be created.

11. A method according to claim 1, comprising determining whether the specified at least one environment is defined as shared.

12. A method according to claim 11, wherein if a developer specifies the at least one environment as a shared environment, the software code is pushed to other developers in the shared environment.

13. A method according to claim 1, comprising determining whether the specified at least one environment is defined as a local.

14. A method according to claim 13, wherein if a developer specifies the at least one environment as a local environment, the software code is not sent to a shared environment and the developer does not appear to have an outgoing changeset.

15. A method according to claim 14, wherein other developers do not see the software code as an incoming changeset.

16. A method according to claim 1, further comprising suggesting an environment to share with another developer or group of developers.

17. A method according to claim 1, further comprising restoring environment-specific values on a local workstation from the central repository.

18. A method according to claim 1, further comprising repeating said method for code changes in a software development lifecycle.

19. A method according to claim 1, wherein a plurality of software code changes are delivered into different specified environments in the central repository, thereby preventing overwriting of different versions of code changes.

20. A method for selective delivery of changesets, comprising:
selecting at least one value in software code changes for a software program;
specifying at least one environment for the selected at least one value via a tag;
compiling the software code changes in each tagged at least one environment;
delivering the software code changes to a central repository;
determining how the tagged at least one environment is defined; and
choosing at least one environment to build against, thereby ensuring that only software code changes for the chosen environment are pulled from the central repository.

21. A method according to claim 20, wherein changesets tagged for a local environment are delivered to the central repository and placed into a local version of the software stream, thereby remaining hidden to other developers.

22. A method according to claim 20, wherein changesets tagged for a shared environment are delivered to the central repository and placed into a shared version of the software stream, thereby being visible to other developers.

23. A system for allowing selective delivery of changesets by environment, comprising:
a plurality of networked local developer workspaces, each workspace connected to a central repository;
a compiler for compiling software code changes in at least one developer workspace or in the central repository; and
at least one environment.

24. A computer program product for selective delivery of changesets, comprising:
a computer readable storage medium;
first program instructions to select at least one value in software code of a software program;
second program instructions to specify at least one environment for the selected at least one value;
third program instructions to compile the software code in each specified at least one environment;
fourth program instructions to deliver the software code to a central repository;
fifth program instructions to determine how the specified at least one environment is defined;
sixth program instructions to choose at least one environment to build against; and
seventh program instructions to pull only software code for the chosen environment from the central repository,
wherein said first, second, third, fourth, fifth, sixth, and seventh program instructions are stored on said computer readable storage medium.
